(19) United States
(12) Patent Application Publication
(10) Pub. No.: US 2003/0213088 A1
(43) Pub. Date: Nov. 20, 2003

(54) Wiper linkage for car and manufacturing method thereof

(75) Inventors: Tae Hun Ju, Incheon-City (KR); Jae Chan Park, Incheon-City (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: DONGYANG MECHATRONICS Co., Ltd., Incheon-City (KR)

(21) Appl. No.: 10/437,814

(22) Filed: May 14, 2003

(30) Foreign Application Priority Data
May 15, 2002 (KR) 10-2002-26733

(51) Int. Cl. B60S 1/06

(52) U.S. Cl. 15/250.3; 15/250.31; 74/42

(57) ABSTRACT

A wiper linkage for a car supporting left and right wiper rotation shafts, the wiper linkage including a body having a plate rod shape in which an upper surface is flat and shaft holes are formed at both end portions, and a shaft rotation support portion rotatably supporting using bearings encompassing the rotation shaft so that the wiper rotation shaft freely rotates and fixed by being inserted in the shaft hole of the body. The operational performance of the wiper is improved and the manufacturing work can be automated so that productivity can be improved. Since the body has a plate shape, when the motor is installed, the accommodation surface is flat so that the motor can be firmly fixed without using an additional sub-bracket. Accordingly, the number of parts decreases so that the manufacturing cost can be reduced. Furthermore, mass production is available due to the insert molding process, a degree of accuracy increases, and the shape can be freely manufactured so that a variety of brackets can be integrally formed on the shaft rotation support portion.

### BACKGROUND OF THE INVENTION

This application claims the priority of Korean Patent Application No. 2002-26733 filed on 15 May 2002 in the Korean Intellectual Property Office, the disclosure of which is incorporated herein in its entirety by reference.

1. Field of the Invention

The present invention relates to a wiper linkage for a car and a method of manufacturing the same, and more particularly, to a wiper linkage for a car which can improve the operation of a wiper by reducing assembly allowance, and a method of manufacturing the same

2. Description of the Related Art

In general, a wiper linkage for a car which supports wiper rotation shafts at the left and right sides is a part of a link engagement apparatus for supporting rotation shafts so that the left and right wipers can move simultaneously.

As shown in FIG. 1, a conventional wiper linkage 100 for a car includes a body 110 having a circular pipe shape, and a shaft rotation support portion 120 manufactured of a plastic material at both end portions of the body 110 and supporting a rotation shaft 1 of a wiper (not shown).

In particular, as shown in a portion B of FIG. 1, the shaft rotation support portion 120 of the wiper linkage 100 for a car is made of independent additional parts. However, since a deviation in a length L between both rotation shafts 1 is great, the operational performance of the wiper is lowered.

Also, since the assembly of a rivet 130 of the portion B is separately performed, productivity is lowered greatly.

Furthermore, since the body 110 has a circular pipe shape, an accommodation surface on which a motor (not shown) is installed is curved. Accordingly, an additional sub-bracket 140 is needed to install the motor so that the installation of the motor is inconvenient. Also, productivity is lowered due to the increased number of parts.

In addition, the conventional method of manufacturing a wiper linkage for a car has problems that mass production is difficult due to the above assembly step, accuracy is lowered, and a change of the shape of the body is difficult.

### SUMMARY OF THE INVENTION

To solve the above and/or other problems, the present invention provides a wiper linkage for a car in which the shaft rotation support portions are formed by plastic insert injection so that the deviation of the length L between both rotation shafts is reduced and the operational performance of a wiper is improved, and a method of manufacturing the same. Also, the assembly step can be automated so that productivity can be improved. Since the body has a plate shape and the accommodation surface on which the motor is installed is made flat, the motor can be firmly installed without an additional sub-bracket. Also, since the number of parts is reduced, manufacturing cost can be reduced.

Also, the present invention provides a wiper linkage for a car in which a variety of brackets can be integrally formed at the shaft rotation support portion by freely manufacturing the shape of the body. Also, mass production is available due to the insert injection work and accuracy can be improved.

According to an aspect of the present invention, a wiper linkage for a car supporting left and right wiper rotation shafts, the wiper linkage comprising a body having a plate rod shape in which an upper surface is flat and shaft holes are formed at both end portions, and a shaft rotation support portion rotatably supporting using bearings encompassing the rotation shaft so that the wiper rotation shaft freely rotates and fixed by being inserted in the shaft hole of the body.

The body is a metal plate where a motor fixing hole fixing a wiper motor is formed on an upper surface and a bent surface is formed in a lengthwise direction to prevent a twist.

The shaft rotation support portion is made of a plastic material and an insert mold which is insert molded on the body and integrally formed with a fixing bracket to fix a shaft connected to a wiper motor.

According to another aspect of the present invention, a method of manufacturing a wiper linkage for a car supporting left and right wiper rotation shafts which comprises the steps of forming a body having a plate rod shape in which an upper surface is flat and shaft holes are formed at both end portions, using a metallic material, and forming a shaft rotation support portion rotatably supporting using bearings encompassing the rotation shaft so that the wiper rotation shaft freely rotates and fixed by being inserted in the shaft hole of the body, using a plastic material, in an individual multiple cavity insert molding or a 2 axes multiple cavity insert molding.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view illustrating a conventional wiper linkage for a car;

FIG. 2 is a perspective view illustrating a wiper linkage for a car according to a preferred embodiment of the present invention;

FIG. 3 is a sectional view illustrating a portion A of FIG. 2;

FIG. 4 is a sectional view illustrating a portion B of FIG. 2;

FIG. 5 is a view illustrating an individual multiple cavity insert molding method of manufacturing a wiper linkage for a car according to a preferred embodiment of the present invention; and

FIG. 6 is a view illustrating a 2 axes simultaneous multiple cavity insert molding method of manufacturing a wiper linkage for a car according to a preferred embodiment of the present invention.

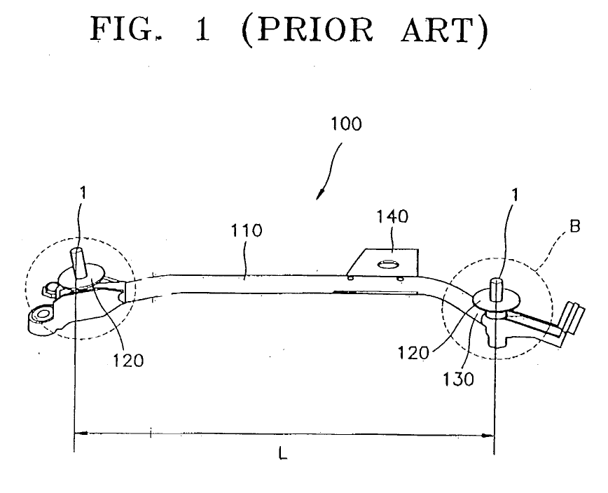

### DETAILED DESCRIPTION OF THE INVENTION

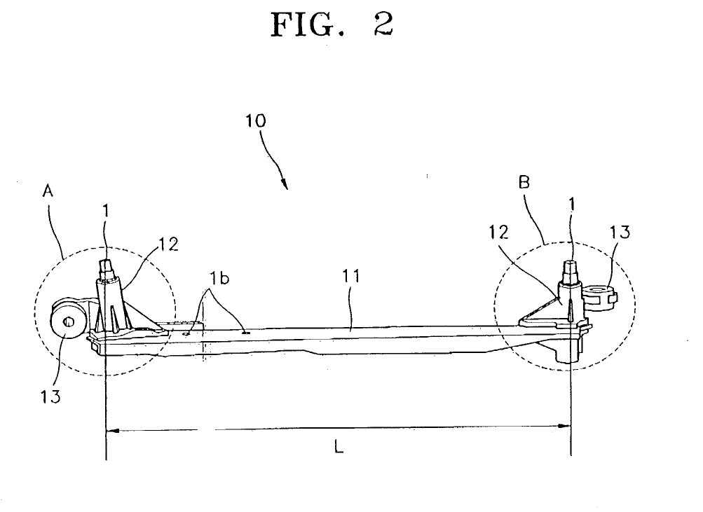

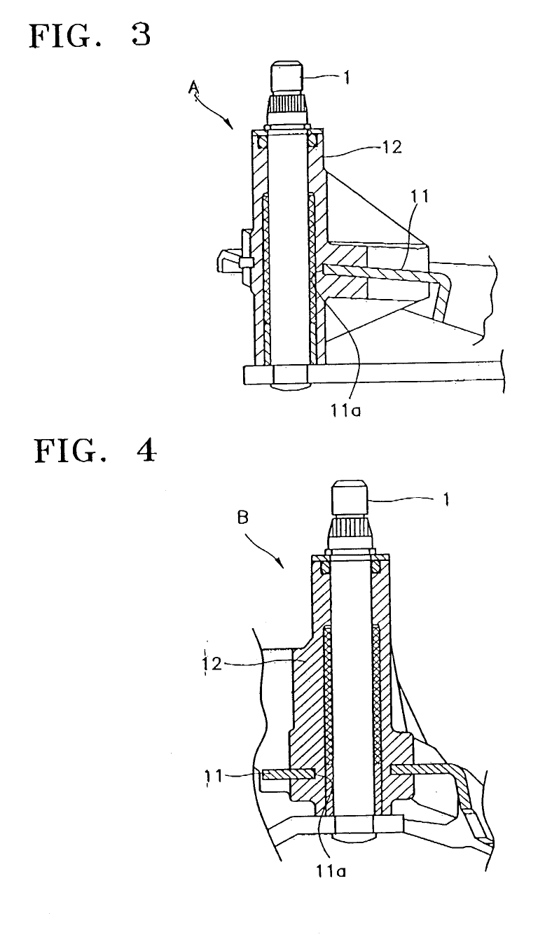

Referring to FIG. 2, a wiper linkage 10 for a car according to a preferred embodiment of the present invention supports left and right wiper rotation shafts of the car and includes a body 11 and a shaft rotation support portion 12. That is, as shown in FIGS. 3 and 4, the body 11 has a plate type rod shape in which an upper surface is flat. A shaft hole 11a in which a rotation shaft 1 is inserted is formed at both end portions formed of portions A and B.

Also, the body 11 is manufactured of a metal plate having a bent surface which is bent in a lengthwise direction. A motor fixing hole 11b to fix a wiper motor (not shown) is formed on a flat upper surface of the body 11. The body 11 can be manufactured in a variety of methods such as a bending method in which a metal plate is cut and pressed or a welding method in which several pieces are welded. Thus, when the wiper motor is installed, since an accommodation surface for accommodating the wiper motor is flat, the wiper motor can be directly and firmly fixed on the body 11 without the conventional additional sub-bracket so that manufacturing cost can be reduced due to the reduction of number of parts.

The shaft rotation support portion 12 support the rotation shaft 1 via bearings so that the rotation shaft 1 can rotate freely, is inserted in the shaft hole 11a of the body 11 and fixed thereto, and is an insert mold which is made of a plastic material insert-molded on the body 11. That is, the shaft rotation support portion 12 is insert-molded on the shaft hole 11a of the body 11 which is made of a metal material. Due to the insert molding structure, a deviation of a length L between both rotation shafts of the wiper is reduced so that the operational performance of the wiper is improved, an assembly work can be automated, and productivity is greatly improved.

Also, since the shaft rotation support portion 12 has an insert injection structure, a variety of shapes of the shaft rotation support portion 12 can be freely made so that a fixing bracket 13 to fix a shaft connected to the motor can be integrally formed simultaneously when the shaft rotation support portion 12 is molded.

In a method of manufacturing a wiper linkage for a car according to a preferred embodiment of the present invention, when the above-described wiper linkage for a car is manufactured, the shaft hole 11a in which the rotation shaft 1 is inserted is formed at both end portions of the wiper linkage. The body 11 having a plate type rod shape having a flat upper surface is manufactured of metal. The wiper rotation shaft 1 is rotatably supported by means of bearings encompassing the rotation shaft 1 so that the wiper rotation shaft 1 can freely rotate. The shaft rotation support portion 12 inserted in the shaft hole 11a of the body 11 and fixed therein is made of a plastic material on the body 11 in an individual multiple cavity insert molding or the 2 axes simultaneous multiple cavity insert molding method.

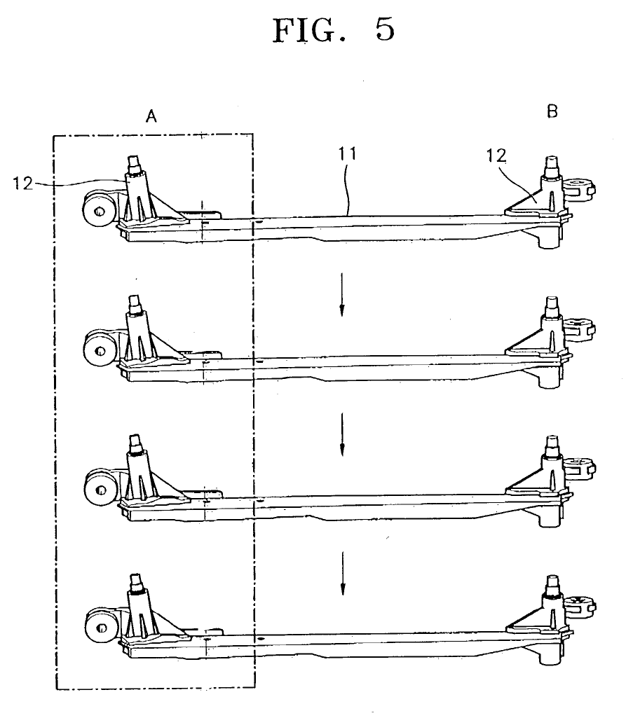

That is, in the individual multiple cavity insert molding method, as shown in FIG. 5, the portion A of the shaft rotation support portion 12 of the wiper linkage for a car according to the present invention is continuously insert injection molded in order on a process line. When the process of the portion A is completed, the portion B is sequentially and continuously insert injection molded.

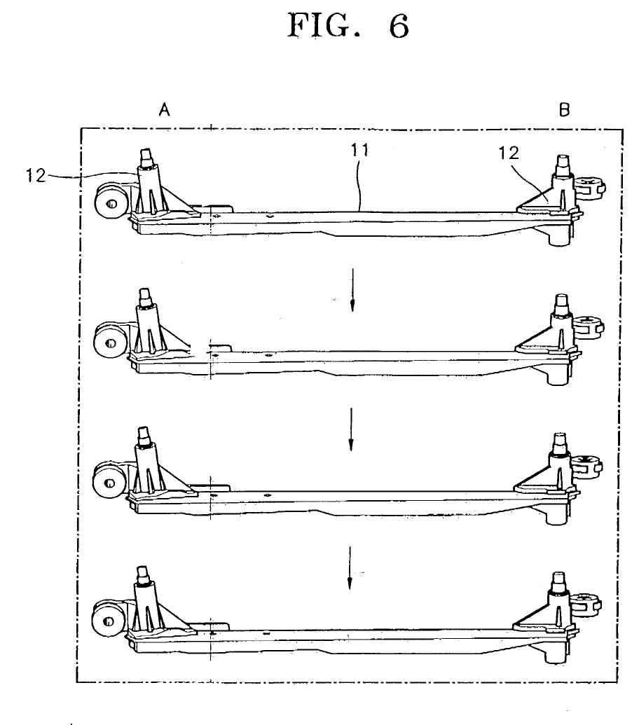

Also, in the 2 axes simultaneous multiple cavity insert molding method, as shown in FIG. 6, both of the portions A and B of the shaft rotation support portion 12 of the wiper linkage for a car according to the present invention are simultaneously insert molded. Since the process is automated by using the individual multiple cavity insert molding or the 2 axes simultaneous multiple cavity insert molding method, the conventional manual manufacturing process such as a rivet assembly can be avoided so that productivity can be improved.

While this invention has been particularly shown and described with reference to preferred embodiments thereof, it will be understood by those skilled in the art that various changes in form and details may be made therein without departing from the spirit and scope of the invention as defined by the appended claims. For example, although the above-described preferred embodiment is limited to the bent body, a rectangular rod shaped body which is not bent or a rectangular pipe type body can be adopted.

As described above, in the wiper linkage for a car according to the present invention and a method of manufacturing the same, the operational performance of the wiper is improved and the manufacturing work can be automated so that productivity can be improved. Also, since the body has a plate shape, when the motor is installed, the accommodation surface is flat so that the motor can be firmly fixed without using an additional sub-bracket. Accordingly, the number of parts decreases so that the manufacturing cost can be reduced. Furthermore, mass production is available due to the insert molding process, a degree of accuracy increases, and the shape can be freely manufactured so that a variety of brackets can be integrally formed on the shaft rotation support portion.

What is claimed is:

1. A wiper linkage for a car supporting left and right wiper rotation shafts, the wiper linkage comprising:
a body having a plate rod shape in which an upper surface is flat and shaft holes are formed at both end portions; and
a shaft rotation support portion rotatably supporting using bearings encompassing the rotation shaft so that the wiper rotation shaft freely rotates and fixed by being inserted in the shaft hole of the body.

2. The wiper linkage as claimed in claim 1, wherein the body is a metal plate where a motor fixing hole fixing a wiper motor is formed on an upper surface and a bent surface is formed in a lengthwise direction to prevent a twist.

3. The wiper linkage as claimed in claim 1, wherein the shaft rotation support portion is made of a plastic material and an insert mold which is insert molded on the body.

4. The wiper linkage as claimed in claim 1, wherein the shaft rotation support portion is integrally formed with a fixing bracket to fix a shaft connected to a wiper motor.

5. A method of manufacturing a wiper linkage for a car supporting left and right wiper rotation shafts, the method comprising the steps of:
forming a body having a plate rod shape in which an upper surface is flat and shaft holes are formed at both end portions, using a metallic material; and
forming a shaft rotation support portion rotatably supporting using bearings encompassing the rotation shaft so that the wiper rotation shaft freely rotates and fixed by being inserted in the shaft hole of the body, using a plastic material, in an individual multiple cavity insert molding or a 2 axes multiple cavity insert molding.
